(19) United States
(12) Patent Application Publication
(10) Pub. No.: US 2014/0074514 A1
(43) Pub. Date: Mar. 13, 2014

(54) Providing a Multi-Line Discount on Insurance in Connection with the Purchase of a Financial Services Product

(71) Applicant: STATE FARM MUTUAL AUTOMOBILE INSURANCE COMPAN, Bloomington, IL (US)

(72) Inventors: Leif A. Roll, Bloomington, IL (US); David Vincent Prus, Normal, IL (US); Jun Wu, Bloomington, IL (US); Gregory Lee Hayward, Bloomington, IL (US); David Lee Menning, Bloomington, IL (US)

(73) Assignee: STATE FARM MUTUAL AUTOMOBILE INSURANCE COMPANY, Bloomington, IL (US)

(21) Appl. No.: 13/672,904

(22) Filed: Nov. 9, 2012

Related U.S. Application Data
(60) Provisional application No. 61/699,545, filed on Sep. 11, 2012.

(51) Int. Cl. G06Q 40/08

(52) U.S. Cl. 705/4

(57) ABSTRACT

Providing a discount for an insurance policy in connection with the purchase of a financial services product. The systems and methods of the present invention automatically apply a discount to an insurance policy held by a customer when the customer purchases and/or maintains a financial services account, such as a deposit account. The insurance policy discount is automatically discontinued when the financial services account is closed.

### CROSS-REFERENCE TO RELATED APPLICATIONS

This application claims the benefit of U.S. Provisional Application No. 61/699,545 filed on Sep. 11, 2012. The contents of which is hereby incorporated by reference in its entirety.

### TECHNICAL FIELD

The present invention relates generally to systems and methods for automatically providing a multi-line discount on an insurance product in connection with purchasing a financial services product, such as a deposit account.

### BACKGROUND

Insurance policies allow consumers to protect against the loss of life or property. For example, a person purchases insurance to cover loss of or damage to his or her automobile. In exchange for the payment of insurance premiums to an insurance provider, the provider agrees to compensate the policyholder in the event of a loss of or damage to the covered property. The covered property can include an automobile, a motorcycle, a recreational vehicle, a boat, or a house or any other property that can be protected by an insurance policy. Often, an insurance company may offer a rate discount to a customer who insures more than one type of property with the same insurance company, such has having auto insurance and homeowner's insurance with the same insurance company. This type of rate discount is referred to as a multi-line discount.

Financial institutions provide a variety of financial services. For example, a financial institution may offer deposit products (referred to as “deposit accounts”), where a customer deposits money with the financial institution in exchange for a financial return on that deposit in the form of interest. The customer makes money on his or her investment while the financial institution can use deposited assets to finance other financial transactions, with the objective of receiving a return from these financial transactions that is greater than the amount of interest owed to the customer of the deposit account. In this way, the financial institution profits from its financial transactions.

Changes in the regulatory environment for financial institutions and insurance companies have made it possible for a company to own both a financial institution and an insurance company. In this case, the financial institution may be part of a larger company that includes both an insurance provider and a financial institution. This case may include the situation where a financial institution owns an insurance provider subsidiary or vice versa. Through this relationship, the financial institution and insurance company can leverage relationships with their customers to cross-sell products from the other institution. Such cross-selling activities may include offering product discounts as an incentive to the customer to maintain its relationships with the financial institution or the insurance company.

Alternatively, the insurance provider may have a business relationship with one or more financial institutions that are independent of the insurance provider, where the business relationship includes the financial institution providing leads to the insurance provider on potential customers. In a third case, a financial institution may establish a relationship with one or more insurance providers for the purpose of receiving leads on potential customers. This working relationship between a financial institution and insurance provider presents opportunities for the insurance provider to provide customers with financial incentives, including a discount on insurance products, in return for customers purchasing financial services products, such as deposit accounts, from the financial institution.

What is needed is an automated system and method for providing a discount for insurance in connection with purchasing a financial services product.

### SUMMARY OF THE INVENTION

The present invention includes systems and methods for automatically providing a discount on insurance in connection with purchasing a financial services product. In one aspect of the present invention, a computer-based method for automatically providing a discounted insurance product is provided. The computer-based method includes the steps of: 1) determining, by a computer associated with an insurance company, that a customer has purchased a financial services product from a financial institution; 2) determining, by the computer, that the customer has an insurance policy with the insurance company, wherein the insurance company is associated with the financial institution; 3) automatically determining and applying, by the computer, a discount on a premium for the insurance policy based on the purchase of the financial services product; and 4) automatically discontinuing, by the computer, the discount on the premium for the insurance policy upon the computer receiving an indication that the financial services product has been discontinued

In another aspect of the present invention, a computer-readable storage medium comprising instructions to be implemented by a computer for automatically providing a discount on insurance is provided. The instructions include: 1) determining, by a computer associated with an insurance company, that a customer has purchased a financial services product from a financial institution; 2) determining, by the computer, that the customer has an insurance policy with the insurance company, wherein the insurance company is associated with the financial institution; 3) automatically determining and applying, by the computer, a discount on a premium for the insurance policy based on the purchase of the financial services product; and 4) automatically discontinuing, by the computer, the discount on the premium for the insurance policy upon the computer receiving an indication that the financial services product has been discontinued.

### BRIEF DESCRIPTION OF THE DRAWINGS

FIG. 1 provides a diagram depicting a computer network in accordance with an exemplary embodiment of the present invention.

FIG. 2 provides a diagram depicting software architecture in accordance with an exemplary embodiment of the present invention.

FIGS. 3a and 3b provide flow diagrams depicting process flows for providing a discounted on insurance in connection with acquiring a deposit account with a financial institution in accordance with an exemplary embodiment of the present invention.

FIG. 4 provides a flow diagram depicting the process flow for determining a multi-line discount in accordance with an exemplary embodiment of the present invention.

FIG. 5 provides a flow diagram depicting the process flow for maintaining a deposit account in accordance with an exemplary embodiment of the present invention.

FIG. 6 provides a flow diagram depicting the process flow for determining a multi-line discount in accordance with an exemplary embodiment of the present invention.

FIG. 7 provides a flow diagram depicting the process flow for maintaining an insurance policy in accordance with an exemplary embodiment of the present invention.

FIG. 8 provides a flow diagram depicting the process flow for identifying potential financial services products to include in multi-line discount in accordance with an exemplary embodiment of the present invention.

### DETAILED DESCRIPTION OF EXEMPLARY EMBODIMENTS

The exemplary embodiments of the present invention provide systems and methods for providing a discount for an insurance product in connection with purchasing a financial services product. More specifically, the present invention provide systems and methods for automatically delivering and administering an insurance product discount in connection with purchasing and maintaining a financial services product such as a deposit account.

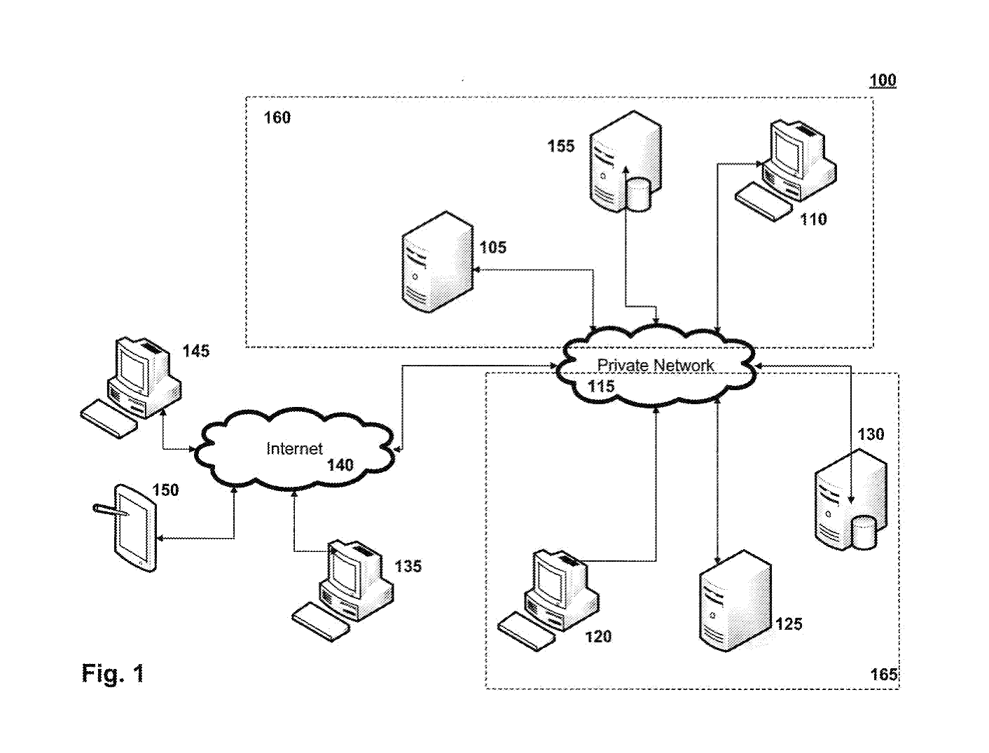

FIG. 1 depicts a computer network 100 in accordance with an exemplary embodiment of the present invention. Referring to FIG. 1, a financial services computer 105 is operable to process applications for financial services products and maintain ongoing financial services products for customers of a financial institution. The financial services computer 105 is connected to other computers over a computer network, such as a private computer network 115 or the Internet 140. The private computer network 115 may be a local area network (LAN) or wide area network (WAN). Connections over the Internet 140 may be accomplished through virtual private network (VPN) protocols or other known secure connections. These other computers can be used to enter information used in processing and maintaining a financial services product on the financial services computer 105 or to configure software resident on the financial services computer 105.

The financial services computer 105 is connected to a financial services workstation 110. A user uses the financial services workstation 110 to access the financial services computer 105, such as for entering information used in processing a request for a financial services product, reviewing the status of the financial services product, or configuring software resident on the financial services computer 105. The financial services workstation 110 can also be used to access other computers attached to the private network 115 or the Internet 140.

The financial services computer 105 is also connected to a financial institution database server 155. The financial institution database server 155 stores information on financial accounts for its customers. The financial services computer 105, financial services workstation 110, and financial institution database server 155 (and, possibly, other computers, not shown) form a financial institution sub-network 160. In an alternative embodiment, the financial services computer 105 and financial services workstation 110 are resident on a network separate from the financial institution database server 155. For example, the financial services computer 105 and financial services workstation 110 may be located at a branch office of a financial institution or operated by a third party contractor. In that case, the financial services computer 105 and financial services workstation 110 would be connected to the financial institution database server 155 over the Internet 140 or through a direct connection, such as a direct communications line between the branch office and the financial institution.

An insurance processing computer 125 is connected to the private network 115. The insurance processing computer 125 is used in providing insurance products to customers of an insurance provider. For example, the insurance processing computer 125 provides workflow information for an insurance agent of the insurance provider operating an insurance workstation 120, which is connected to the insurance processing computer 125 by the private network 115. The agent uses the insurance workstation 120 to work items in his or her workflow. Workflow items can include requests for insurance products, insurance claim follow-up, and other activities

The insurance processing computer 125 is also connected to one or more other computers, such as an insurance database server 130. The insurance database server 130 includes data files with information on customers, including personal identifying information and insurance products and services purchased by the customer. The insurance processing computer 125, insurance workstation 120, and insurance database server 130 (and, possibly, other computers, not shown) form an insurance provider sub-network 165. As seen in the exemplary network architecture of FIG. 1, the components of the insurance provider sub-network 165 are connected to components of the financial institution sub-network 160 through a private network 115, such as may be the case for an insurance provider and financial institution that are part of the same company. In an alternative embodiment, the components of the insurance provider sub-network 165 are connected to components of the financial institution sub-network 160 through a public network such as the Internet 140, such as may be the case when the insurance provider and financial institution have a contractual, rather than corporate, relationship.

Customers may access components on the financial institution sub-network 160 or insurance provider sub-network 165 through a connection to the Internet 140 using a personal computer 145 or other computing device, such as a smartphone or kiosk (not shown) or tablet computer 150. For example, a customer may be able to apply for financial services, including a deposit account, from the financial institution or insurance products from the insurance provider by accessing the financial institution sub-network 160 or insurance provider sub-network 165 through the Internet 140. Also, an independent agent of the insurance provider may connect to the insurance processing computer 125 through a personal computer 135 connected to the Internet 140.

Typically, the insurance provider sub-network 165 and the financial institution sub-network 160 will include a firewall or other appropriate security infrastructure to protect the information resident on the computers on each network. These security infrastructures protect customers' confidential information resident on the computers. Processes used by computers that interact from one sub-network to another, such as a computer on the insurance provider sub-network 165 accessing a computer on the financial institution sub-network 160 or a computer on the financial institution sub-network 160 accessing a computer on the insurance provider sub-network 165 will include appropriate security protocols to prevent the unauthorized access of information. Similarly, the insurance provider sub-network 165 and the financial institution sub-network 160 will include security protocols to prevent customers from unauthorized access to information on the sub-networks. Also, the insurance provider sub-network 165 and the financial institution sub-network 160 will include security protocols to protect confidential information supplied by a customer to one of the sub-networks, such as by accessing the insurance provider sub-network 165 or the financial institution sub-network 160 using the personal computer 145 or other computing device, such as a smartphone or kiosk (not shown) or tablet computer 150. For example, a customer will communicate with the insurance provider sub-network 165 or the financial institution sub-network 160 using a secure website that protects the security of information entered into the website by the customer. Accordingly, the interactions between computer modules resident on computers on the insurance provider sub-network 165 or the financial institution sub-network 160 described below include processes for communicating through the security infrastructure.

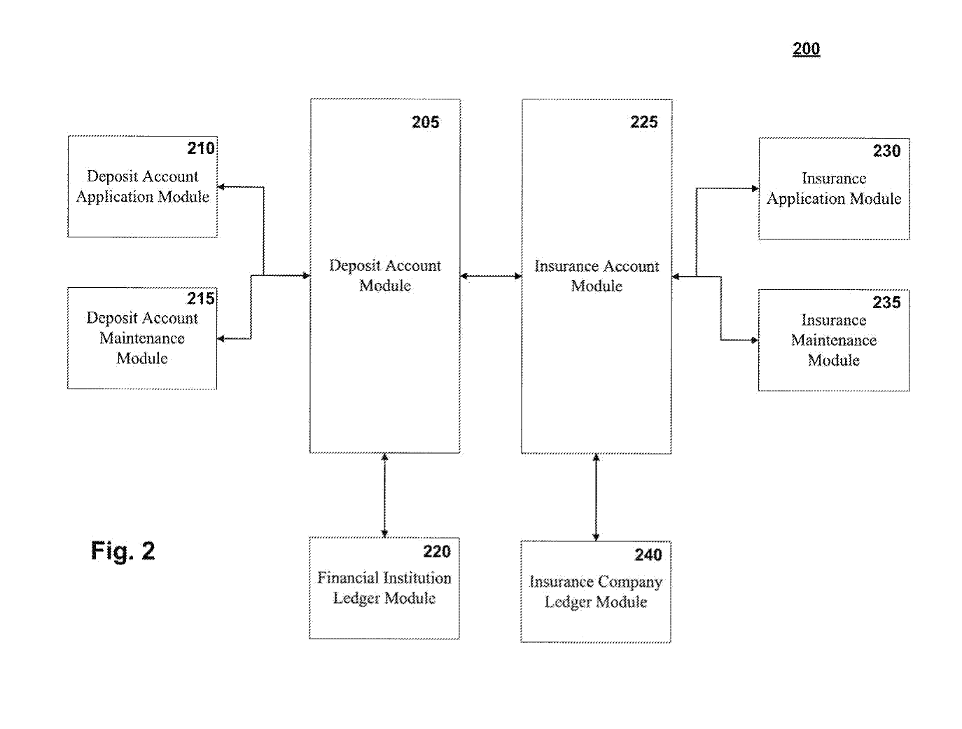

FIG. 2 provides a diagram depicting software architecture 200 in accordance with an exemplary embodiment of the present invention. The depicted software architecture 200 is exemplary and the functions of specific modules discussed below could be performed by other modules (including modules identified in the architecture 200 or other modules not identified). Referring to FIGS. 1 and 2, a deposit account module resident on the financial services computer 105 interacts with a deposit account application module 210 and a deposit account maintenance module 215. The deposit account application module 210 receives information about a customer who desires to open a deposit account with the financial institution. This information may be received directly from a customer, such as a customer interacting with the financial services computer 105 over the Internet 140 using the personal computer 145 or other computing device, such as a smartphone or kiosk (not shown) or tablet computer 150. Alternatively, the information may be entered using the financial services workstation 110 operated by an employee of the financial institution. The information would include all information required by the financial institution for the customer to open the deposit account. The information may also include an indication as to whether the customer has a current insurance policy with an insurance company associated with the financial institution, such as an insurance company with a corporate affiliation to the financial institution. The information received by the deposit account application module 210 is transferred to the deposit account module 205 and stored in the financial services database server 155.

The deposit account maintenance module 215 performs operations required to maintain the financial account. Exemplary processes may include calculating interest and preparing statements. Additionally, the account maintenance module 215 receives indications that an account is to be closed. Such information would be pushed to the deposit account module 205.

The deposit account module 205 interacts with an insurance account module 225 resident on an insurance processing computer 125. The deposit account module 205 pushes information to the insurance account module 225 including an indication that an insurance customer has opened or closed a deposit account.

The insurance account module 225 interacts with an insurance application module 230 and an insurance maintenance module 235. The insurance application module 230 receives information about a customer who desires to open insurance policy with the insurance company. This information may be received directly from a customer, such as a customer interacting with the insurance processing computer 125 over the Internet 140 using the personal computer 145 or other computing device, such as a smartphone or kiosk (not shown) or tablet computer 150. Alternatively, the information may be entered using the insurance workstation 120 operated by an employee or agent of the insurance company. The information would include all information required by the insurance company for the customer to open the policy. The information may also include an indication as to whether the customer has a current deposit account with a financial institution associated with the insurance company, such as a financial institution with a corporate affiliation to the insurance company.

The insurance maintenance module 235 performs operations required to maintain the customer's insurance policies. Exemplary processes may include performing actuarial analyses to determine insurance rates and preparing bills. Additionally, the insurance maintenance module 235 receives indications that a financial deposit account associated with a multi-line discount on an insurance premium for an insurance customer has been opened or is to be closed. Such information would be received from the deposit account module 205 through the insurance account module 225. In response to receiving this information, the insurance maintenance module 235 adjusts the premium rate of the customer's insurance policy accordingly. In one embodiment, this information is pushed to the insurance account module 225 and/or the deposit account maintenance module 215 from the deposit account module 205. In an alternative embodiment, the insurance account module 225 and/or insurance maintenance module 235 poll the deposit account module 205 to confirm that the deposit account for a particular customer is still active.

The insurance account module 225 interacts with the deposit account module 205. Such interactions may include providing an indication that a financial institution customer does or does not have an insurance policy with the insurance company.

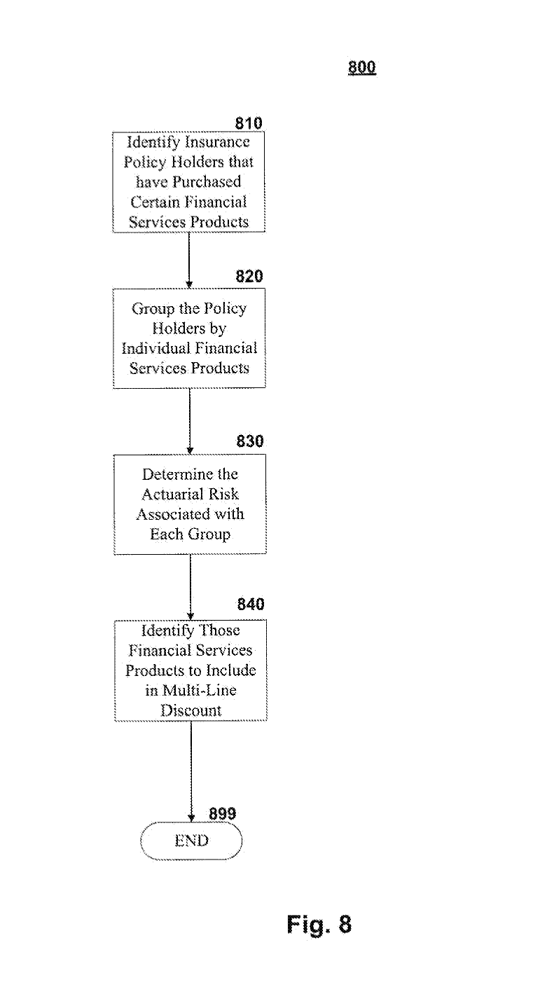

In one exemplary embodiment, the “cost” of providing the insurance discount is absorbed by the insurance company. For example, the discount in the premium may be recovered by the insurance company due to the risk profile for a customer with a deposit account as compared to a customer without a deposit account. This concept is discussed in greater detail below, in connection with FIG. 8. Alternatively, the deposit account module 205 also may interact with a financial institution ledger module 220 and the insurance account module 225 also interacts with an insurance company ledger module 240. An insurance company and financial institution typically would determine the “cost” of the provided discount to insurance customers who also have a deposit account with the financial institution. The financial institution may reimburse the insurance company some or all of the amount of the discounts provided to customers. These ledger modules track the amount of any discounts and the amount of any reimbursement.

The above example is based on a company that has both a financial institution subsidiary and an insurance provider subsidiary. The same scenarios could exist where an insurance provider has a contractual relationship with one or more financial institutions, where the financial institutions do not have a corporate relationship with the insurance provider. In this situation, the insurance provider contracts with the financial institutions to receive leads on financial institution customers seeking insurance products. Through the relationship between the insurance provider and financial institution, a financial institution customer could receive a discount on insurance for opening a financial services account. Further, the above example is based on a deposit account. Other financial services accounts, such as brokerage accounts or loans, could serve as the basis for the insurance discount without deviating from present invention.

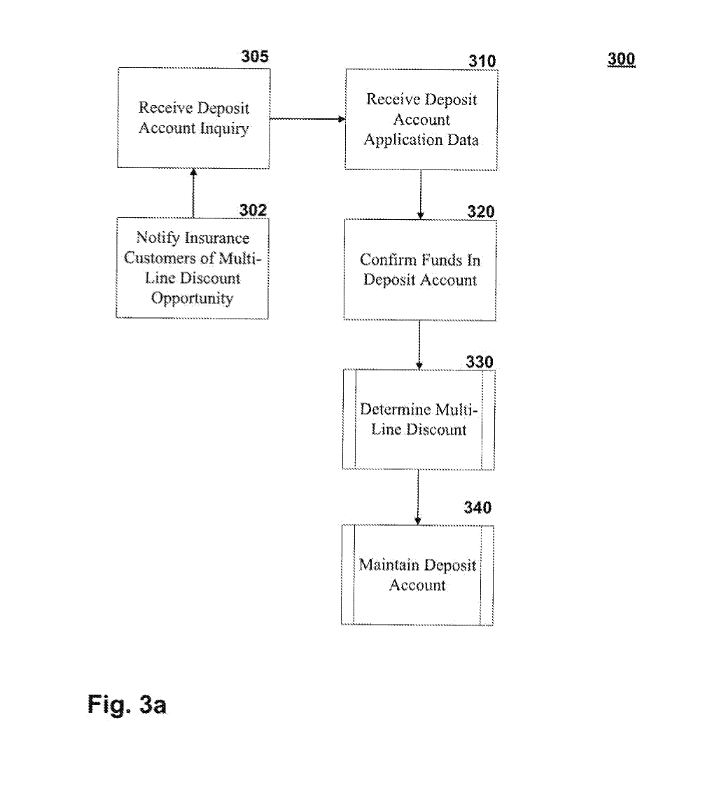

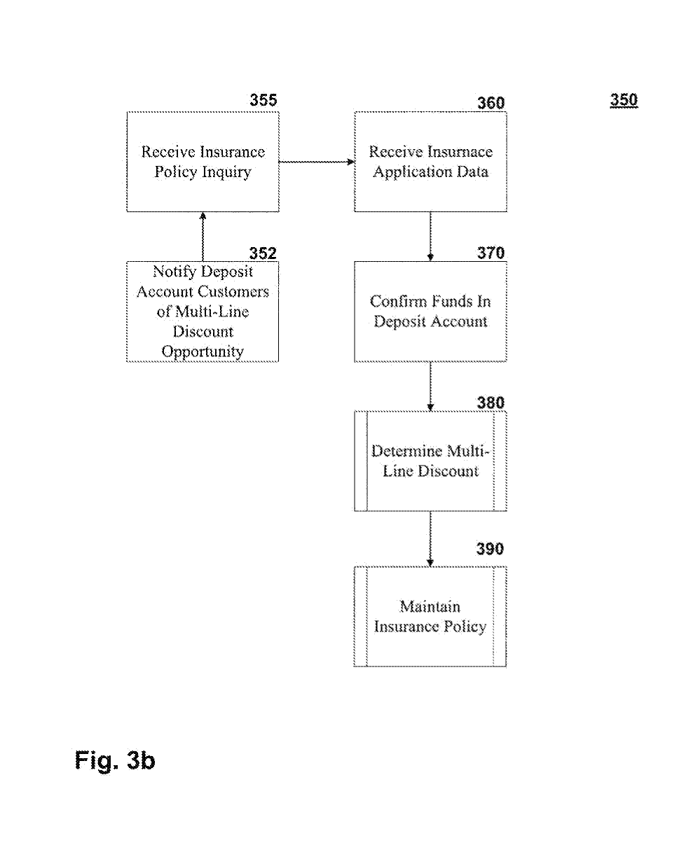

FIG. 3a provides a flow diagram depicting the process flow 300 for providing a discount on insurance in connection with acquiring a deposit account with a financial institution in accordance with an exemplary embodiment of the present invention. Referring to FIGS. 1, 2, and 3a, at step 302, the insurance account module 225 sends a notification to a customer that has one or more insurance policies with the insurance company that the customer could receive a discount by opening a deposit account with the financial institution. At step 305, in response to the notification sent at step 302, a customer submits a deposit account inquiry, which is received by the deposit account application module 210. For example, the notification at step 302 may be an electronic mail message that includes an embedded link. By actuating the link, the customer is taken to a website that facilitates the customer enter information needed for the deposit account inquiry. Alternatively, step 302 may be omitted and a customer submits a deposit account inquiry, which is received by the deposit account application module 210. Step 305 may be triggered by some other type of advertising by the financial institution or insurance company or may be initiated by the customer on his or her own.

At step 310, the deposit account application module 210 receives deposit account application data from a customer. In response to the inquiry at step 305, the deposit account application module 210 provides a mechanism to receive information from the customer. For example, the deposit account application module 210 may provide one or more web pages that requests information. Alternatively, information may be entered by a representative of the financial institution, such as by entering data into a form using financial services workstation 110. For example, in response to the inquiry at step 305, the deposit account module 205 may send an electronic message to the customer providing a telephone number for the customer to call or a branch location for the customer to visit. As another example, the inquiry at step 305 may trigger an action from a customer services representative of the financial institution to call the customer and take the information over the telephone. The information provided by the customer may include an indication that the customer has an insurance policy with an insurance company associated with the financial institution. For example, a web page used to collect the customer's information may include an entry field for entering information on an insurance policy with an associated insurance company.

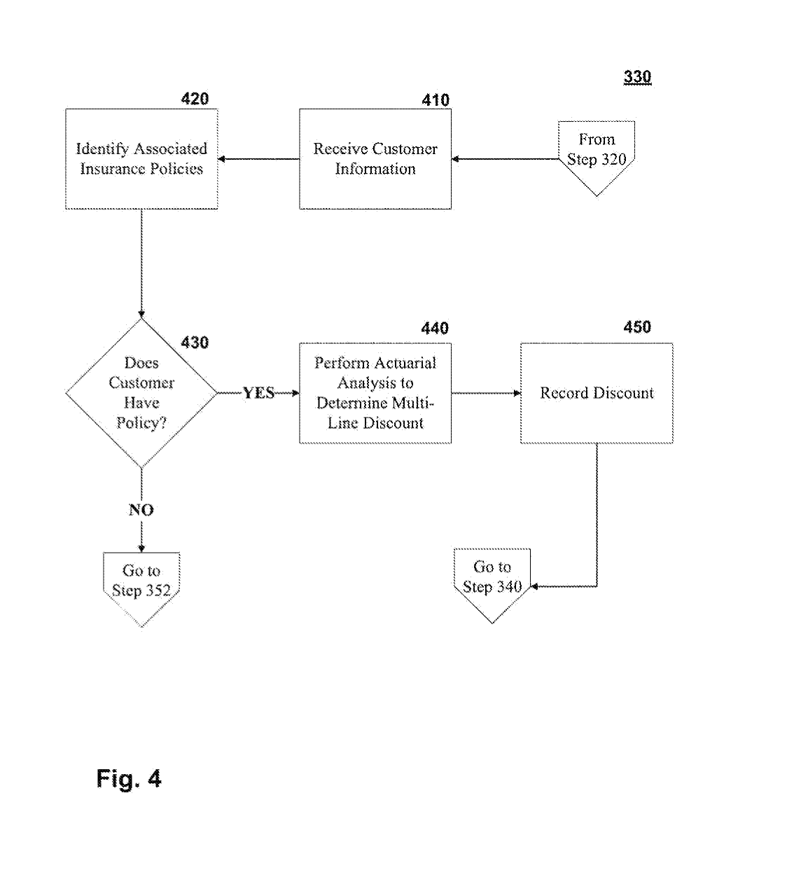

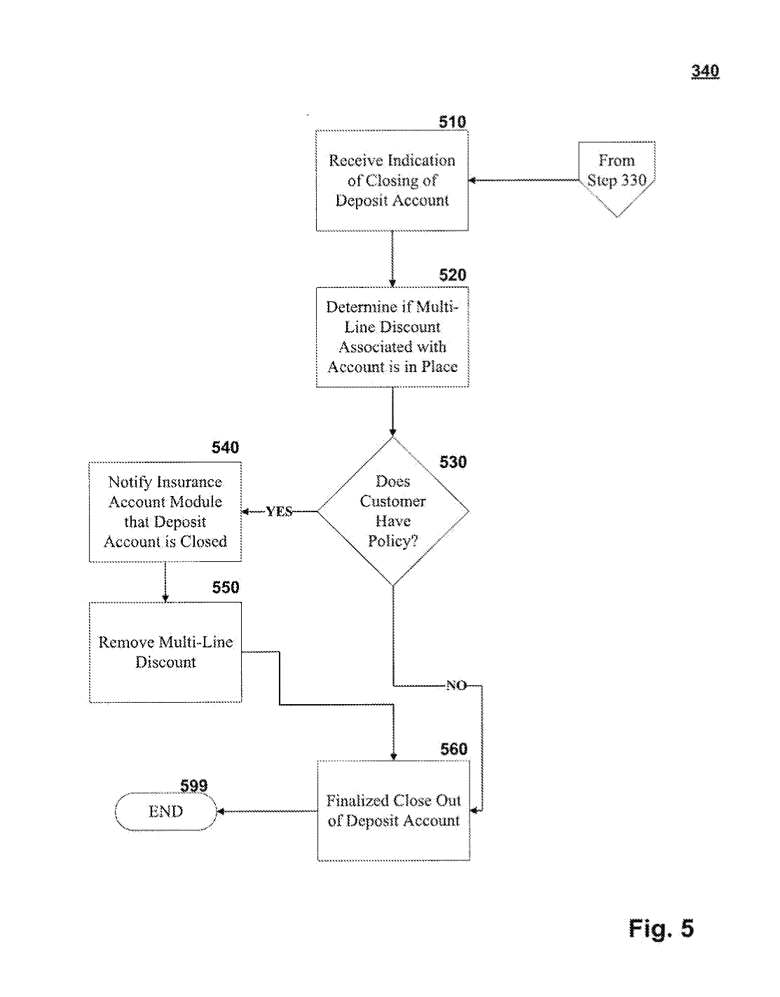

At step 320, the deposit account module 205 confirms that funds have been placed into a newly-opened deposit account. At step 330, the insurance account module 225 determines any applicable multi-line discount based on the deposit account. This step is discussed in greater detail at FIG. 4, below. At step 340, the deposit account module 205 and the deposit account maintenance module 215 maintain the deposit account. This step is discussed in greater detail at FIG. 5, below.

FIG. 3b provides a flow diagram depicting the process flow 350 for providing a discount on insurance in connection with acquiring a deposit account with a financial institution in accordance with an exemplary embodiment of the present invention. Referring to FIGS. 1, 2, and 3b, at step 352, the deposit account module 205 sends a notification to a customer that has one or more deposit accounts with the financial institution that the customer could receive a discount by purchasing insurance from an associated insurance company. At step 355, in response to the notification sent at step 352, a customer sends in an insurance policy inquiry, which is received by the insurance application module 230. For example, the notification at step 352 may be an electronic mail message that includes an embedded link. By actuating the link, the customer is taken to a website that facilitates the customer enter information needed for the insurance policy inquiry. Alternatively, step 352 may be omitted and a customer sends in an insurance policy inquiry, which is received by the insurance application module 230. Step 355 may be triggered by some other type of advertising by the financial institution or insurance company or may be initiated by the customer on his or her own.

At step 360, the insurance application module 230 receives an insurance application data from a customer. In response to the inquiry at step 355, the insurance application module 230 provides a mechanism to receive information from a customer. For example, the insurance application module 230 may provide one or more web pages that requests information. Alternatively, information may be entered by a representative of the insurance company, such as an agent or customer service representative, such as by entering data into a form using insurance workstation 120. For example, in response to the inquiry at step 355, the insurance account module 225 may send an electronic message to the customer providing a telephone number for the customer to call or a branch location for the customer to visit. As another example, the inquiry at step 355 may trigger an action from a customer services representative of the insurance company to call the customer and take the information over the telephone. The information provided by the customer may include an indication that the customer has a financial services account, such as a deposit account, with a financial institution associated with the insurance company. For example, a web page used to collect the customer's information may include an entry field for entering information on financial services account with an associated financial services institution.

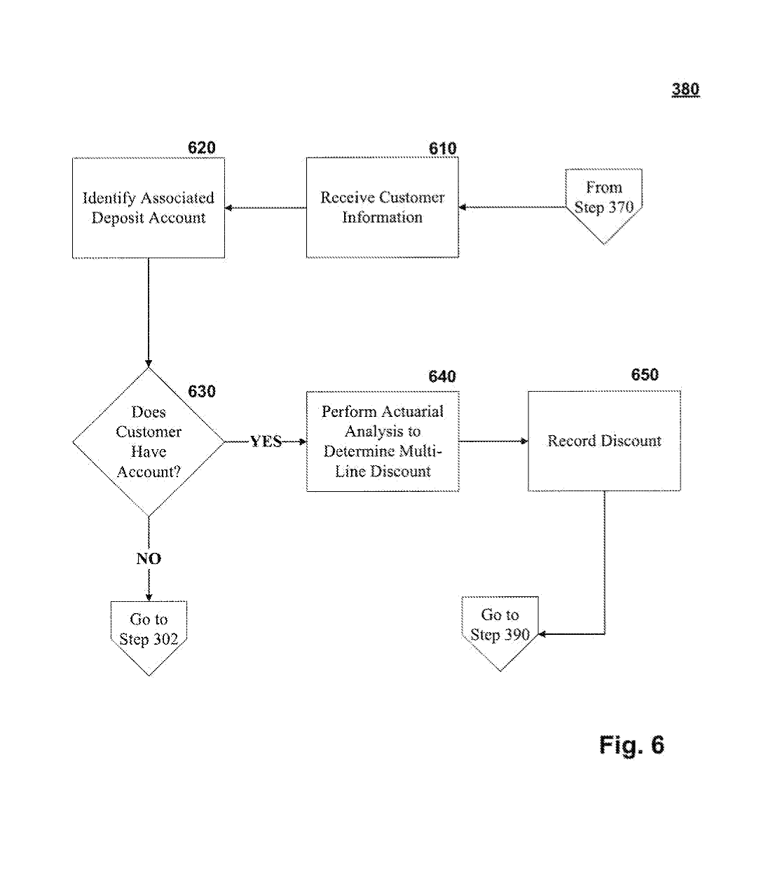

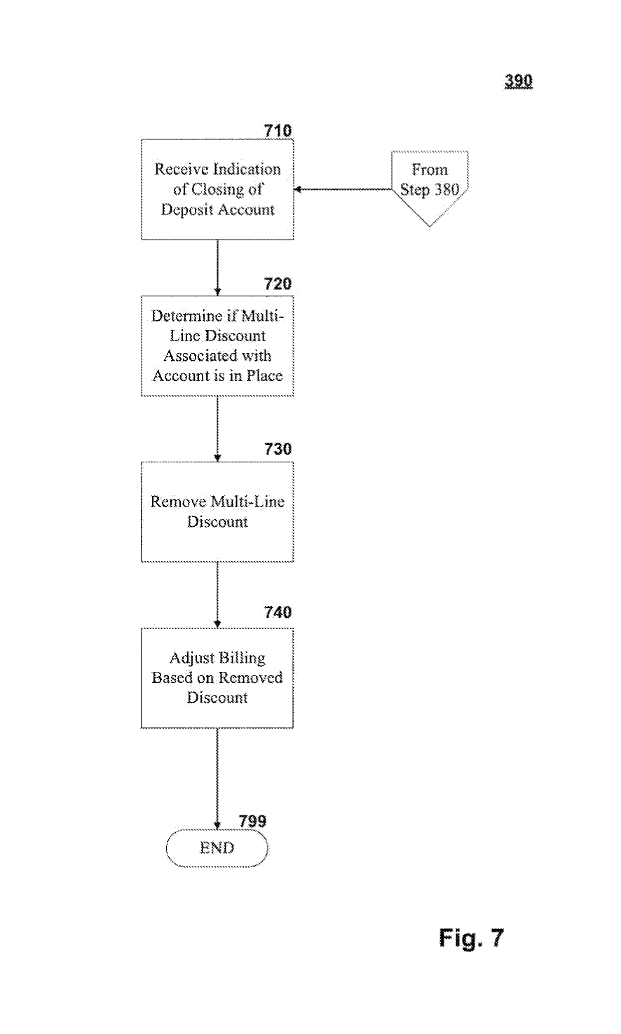

At step 370, the insurance account module 225, through the deposit account module 205, confirms that funds have been placed into a newly-opened deposit account. At step 380, the insurance account module 225 determines any applicable multi-line discount based on the deposit account. This step is discussed in greater detail at FIG. 6, below. At step 390, the insurance account module 225 and the insurance maintenance module 235 maintains the insurance policy. This step is discussed in greater detail at FIG. 7, below.

FIG. 4 provides a flow diagram depicting the process flow 330 for determining a multi-line discount in accordance with an exemplary embodiment of the present invention. Referring to FIGS. 1, 2, 3a, and 4, at step 410, the insurance account module 225 receives customer information regarding a customer and the financial services products that the customer has with an associated financial institution. At step 420, the insurance account module 225 identifies one or more insurance policies that the customer has with the insurance company, such as by querying a database of customer information on the insurance database server 130 by using certain personal identifying information on the customer received at step 410. At step 430, the insurance account module 225 determines if the customer has an insurance policy that can receive a multi-line discount on its premium based on the customer having a deposit account or other financial services product with an associated financial institution.

If the result of the inquiry at step 430 is “No,” the process 330 to step 352 (FIG. 3b). If the result of the inquiry at step 430 is “Yes,” the process 330 moves to step 440, where the insurance account module 225 performs an actuarial analysis to determine the amount of the multi-line discount available to the customer. This determination may be based on factors such as the type of policy involved (for example, auto insurance, home owners insurance, boat insurance, life insurance), whether the policy is entitled to other discounts (for example, multi-line discount for other insurance policies, good student discount, etc.), and the risk of loss associated with the policy, such that the amount of the discount (absolute amount or percentage of premium) may vary from customer to customer. In other exemplary embodiments, the discount may be a fixed percentage of a premium or fixed dollar amount applied in all cases.

At step 450, the insurance account module 225 records the existence and amount of the discount in a database record associated with the customer and insurance policy on the insurance database server 130. Additionally, the insurance account module 225 may notify the deposit account module 205 of the existence of a multi-line discount associated with a customer's deposit account. This characteristic of the customer's deposit account may be recorded in a database record associated with the customer and deposit account stored on the financial institution database server 155. The process 330 then moves to step 340.

FIG. 5 provides a flow diagram depicting the process flow 340 for maintaining a deposit account in accordance with an exemplary embodiment of the present invention. Process flow 340 represents a sub-activity associated with the overall activity of maintaining a deposit account from the standpoint of the financial institution that holds the account. A number of sub-activities are associated with this overall activity, including updating status changes to the account and deposits and withdrawals, determining accrued interest and account balances, responding to customer inquires, and reporting to customers. Process flow 340 is focused on a subset of actions triggered when the customer closes the deposit account with the financial institution.

Referring to FIGS. 1, 2, 3a, and 5, at step 510, the deposit account maintenance module 215 receives an indication that a customer is closing a deposit account. This indication may come from a customer accessing components on the financial institution sub-network 160 through a connection to the Internet 140 using a personal computer 145 or other computing device, such as a smartphone or kiosk (not shown) or tablet computer 150. Alternatively, information on the account closing may be entered by a representative of the financial institution, such as by entering data into a form using financial services workstation 110.

At step 520, the deposit account maintenance module 215 determines if the customer closing the deposit account also has an insurance policy with an associated insurance company and has a multi-line discount for a premium on the insurance policy because the customer has a deposit account with the financial institution. This determination may be made by the deposit account maintenance module 215 querying the financial institution database server 155 to determine if the database records associated with the customer and deposit account includes an indication of the existence of a multi-line discount. Alternatively, this determination may be made by the deposit account maintenance module 215 querying the insurance account module 225, which would in turn query the insurance database server 130 to determine if the database records associated with the customer includes an indication of the existence of a multi-line discount.

At step 530, the deposit account maintenance module 215 decides if the customer has a policy with a discount associated with the deposit account being closed. If the result of the decision at step 530 is “No,’ the process 340 moves to step 560 and finalizes the closing of the deposit account. The process 340 then ends. If the result of the decision at step 530 is “Yes,’ the process 340 moves to step 540 and notifies the insurance account module 225 that the customer's deposit account is being closed.

At step 550, the insurance account module 225 removes the discount from the policy premium and updates the database record associated with the customer and insurance policy on the insurance database server 130. This removal may trigger a revised bill being sent to the customer for an additional premium amount. Then, the process 340 moves to step 560 and finalizes the closing of the deposit account. The process 340 then ends.

FIG. 6 provides a flow diagram depicting the process flow 380 for determining a multi-line discount in accordance with an exemplary embodiment of the present invention. Referring to FIGS. 1, 2, 3b, and 6, at step 610, the insurance account module 225 receives customer information regarding a customer and the financial services products that the customer has with an associated financial institution. This reception of information may be the result of a query from the insurance account module 225 or information pushed to the insurance account module 225. At step 620, the insurance account module 225 identifies one or more financial services products that the customer has with the associated financial institution. At step 630, the insurance account module 225 determines if the customer has a financial services product, such as a deposit account, that can qualify the customer for a multi-line discount on an insurance premium.

If the result of the inquiry at step 630 is “No,” the process 380 to step 302 (FIG. 3a). If the result of the inquiry at step 630 is “Yes,” the process 380 moves to step 640, where the insurance account module 225 performs an actuarial analysis to determine the amount of the multi-line discount available to the customer. This determination may be based on factors such as the type of policy involved (for example, auto insurance, home owners insurance, boat insurance, life insurance), whether the policy is entitled to other discounts (for example, multi-line discount for other insurance policies, good student discount), and the risk of loss associated with the policy, such that the amount of the discount (absolute amount or percentage of premium) may vary from customer to customer. In other exemplary embodiments, the discount may be a fixed percentage of a premium or fixed dollar amount applied in all cases.

At step 650, the insurance account module 225 records the existence and amount of the discount in a database record associated with the customer and insurance policy on the insurance database server 130. Additionally, the insurance account module 225 may notify the deposit account module 205 of the existence of a multi-line discount associated with a customer's deposit account. This characteristic of the customer's deposit account may be recorded in a database record associated with the customer and deposit account stored on the financial institution database server 155. The process 380 then moves to step 390.

FIG. 7 provides a flow diagram depicting the process flow 390 for maintaining an insurance policy in accordance with an exemplary embodiment of the present invention. Process flow 390 represents a sub-activity associated with the overall activity of maintaining an insurance policy from the standpoint of the insurance company. A number of sub-activities are associated with this overall activity, including updating status changes, determining premiums, responding to customer inquires, and billing customers. Process flow 390 is focused on adjusting a customer's premium based on the closing, by that customer, of a deposit account with an associated financial institution.

Referring to FIGS. 1, 2, 3b, and 7, at step 710, the insurance maintenance module 235 receives an indication that an insurance company customer who has purchased financial services such as a deposit account from an associated financial institution is closing the deposit account. This indication may come from a customer accessing components on the financial institution sub-network 160 through a connection to the Internet 140 using a personal computer 145 or other computing device, such as a smartphone or kiosk (not shown) or tablet computer 150. Alternatively, information on the account closing may be entered by a representative of the financial institution, such as by entering data into a form using financial services workstation 110. The insurance maintenance module 235 receives the information at step 710 as part of a push process, where the deposit account module 205 pushes the information to the insurance maintenance module 235. This push activity may be triggered by an indication in the database record associated with the deposit account that the customer is receiving a multi-line discount on insurance from an associated insurance company for as long as that customer has the deposit account active. Alternatively, the insurance maintenance module 235 may periodically poll the deposit account module 205 to determine if a deposit account that serves as the basis for a multi-line discount is still active. In yet another alternative, the deposit account module 205 informs the insurance maintenance module 235 of all account closings to allow the insurance maintenance module 235 to determine if the closing affects any discounts.

If necessary, at step 720, the insurance maintenance module 235 determines if the customer closing the deposit account also has an insurance policy with an associated multi-line discount for a premium on the insurance policy.

At step 730, the insurance account module 225 and/or the insurance maintenance module 235 removes the discount from the policy premium and updates the database record associated with the customer and insurance policy on the insurance database server 130. This removal may trigger a revised bill being sent to the customer for an additional premium amount, which is performed at step 740. The process 390 then ends.

FIG. 8 provides a flow diagram depicting the process flow 800 for identifying potential financial services products to include in a multi-line discount in accordance with an exemplary embodiment of the present invention. Referring to FIGS. 1, 2, and 8, at step 810, the insurance account module 225 identifies policyholders that have purchased one or more financial services products from an associated financial institution. This identification may include querying the insurance database server 130 and financial services database server 155. At step 820, policyholders are grouped by purchased financial services products. For example, all policyholders that have purchased deposit accounts would be identified in one group. All policyholders that have purchased investment accounts would be identified in a second group. Policyholders that have purchased both products would be included separately in both groups. A third group may be policyholders that have loan products from the financial institution. Additionally, a fourth group may be formed of policyholders with multiple products, such as a deposit account and investment accounts or a deposit account and a loan.

At step 830, the insurance account module 225 applies known actuarial models to determine the risk profiles of each group. The results of this modeling activity will be a characterization of the risk associated with each group. For example, the result may indicate that policyholders with deposit accounts have a lower-than-expected risk profile as compared to an average group of policyholders while policyholders with investment accounts have a higher-than expected risk profile as compared to an average group of policyholders.

At step 840, the insurance account module 225 identifies those financial services products to be considered for a multi-line discount. For example, those products with lower-than-expected risk profiles may be eligible for a discount while those products with higher-than-expected risk profiles may not be eligible. In that way, the premium discount provided to lower risk customers is likely not to “cost” the insurance company, as the reduced premiums would be offset by lower payouts by the insurance company for these customers. Further, the discount would encourage the customer to stay with the insurance company, causing a lower overall risk associated with the insured pool of customers.

Process 800 then ends. Process 800 can be run periodically to adjust which financial services products serve as the basis for a discount. Typically, this adjustment would be implemented with customers going forward (as opposed to removing a discount for an existing customer). However, removing a discount for an existing customer after a reassessment would not be outside the scope of the present invention.

For the purposes of this disclosure, the term exemplary means example only. Although the disclosed embodiments are described in detail in the present disclosure, it should be understood that various changes, substitutions and alterations can be made to the embodiments without departing from their spirit and scope.

1. A computer-based method for automatically providing a discount on insurance comprising the steps of:
determining, by a computer associated with an insurance company, that a customer has purchased a financial services product from a financial institution;
determining, by the computer, that the customer has an insurance policy with the insurance company, wherein the insurance company is associated with the financial institution;
automatically determining and applying, by the computer, a discount on a premium for the insurance policy based on the purchase of the financial services product, wherein determining the discount comprises:
identifying a group of insurance policy customers that have purchased the financial services product;
determining an actuarial risk profile associated with the identified group of insurance policy customers that have purchased the financial services product;
determining an amount of the discount based on the determined actuarial risk profile associated with the identified group insurance policy customers; and
automatically discontinuing, by the computer, the discount on the premium for the insurance policy upon the computer receiving an indication that the financial services product has been discontinued.

2. The method of claim 1, wherein the financial services product is a deposit account.

3. The method of claim 1 wherein the insurance policy is an auto insurance policy.

4. The method of claim 1 wherein the financial institution and insurance company are part of the same company.

5. (previously canceled)

6. (previously canceled)

7. The method of claim 1 wherein the step of determining that a customer has purchased a financial services product from a financial institution further comprises the computer associated with an insurance company receiving an indication that the customer has purchased a financial services product from a financial institution from a computer associated with the financial institution.

8. A non-transitory computer-readable storage medium comprising instructions to be implemented by a computer for automatically providing a discount on insurance, the instructions comprising:
determining, by a computer associated with an insurance company, that a customer has purchased a financial services product from a financial institution;
determining, by the computer, that the customer has an insurance policy with the insurance company, wherein the insurance company is associated with the financial institution;
automatically determining and applying, by the computer, a discount on a premium for the insurance policy based on the purchase of the financial services product, wherein determining the discount comprises:
identifying a group of insurance policy customers that have purchased the financial services product;
determining an actuarial risk profile associated with the identified group of insurance policy customers that have purchased the financial services product;
determining an amount of the discount based on the determined actuarial risk profile associated with the identified group insurance policy customers; and
automatically discontinuing, by the computer, the discount on the premium for the insurance policy upon the computer receiving an indication that the financial services product has been discontinued.

9. The non-transitory computer-readable storage medium of claim 8, wherein the financial services product is a deposit account.

10. The non-transitory computer-readable storage medium of claim 8 wherein the insurance policy is an auto insurance policy.

11. The non-transitory computer-readable storage medium of claim 8 wherein the financial institution and insurance company are part of the same company.

12. (previously canceled)

13. (previously canceled)

14. The non-transitory computer-readable storage medium of claim 8 wherein the instruction for determining that a customer has purchased a financial services product from a financial institution further comprises the computer associated with an insurance company receiving an indication that the customer has purchased a financial services product from a financial institution from a computer associated with the financial institution.
